(19) United States
(12) Patent Application Publication
(10) Pub. No.: US 2020/0138017 A1
(43) Pub. Date: May 7, 2020

(54) PESTICIDE

(71) Applicant: Crop Protection Technology Pte. Ltd., Singapore (SG)

(72) Inventors: Eng Soon Teo, Singapore (SG); Brook C. Murphy, Davis, CA (US)

(73) Assignee: Crop Protection Technology Pte. Ltd., Singapore (SG)

(21) Appl. No.: 16/607,705

(22) PCT Filed: May 3, 2018
(86) PCT No.: PCT/SG2018/050218

§ 371 Date: Oct. 23, 2019

Related U.S. Application Data
(63) Continuation-in-part of application No. 15/969,756, filed on May 2, 2018, now abandoned.

(30) Foreign Application Priority Data
May 3, 2017 (SG) 10201703634R

(51) Int. Cl. A01N 25/04; A01N 65/00

(52) U.S. Cl. CPC A01N 25/04; A01N 65/00

(57) ABSTRACT

The present invention relates to a pesticide nano-emulsion comprising: (a) a horticultural oil as an active ingredient; (b) a mixture of inert ingredients comprising: (i) an emulsifier; (ii) a stabilizer; and (iii) a surfactant; and (c) a solvent, wherein the horticultural oil is dispersed as droplets in the solvent to form the nano-emulsion.

### CROSS REFERENCE TO RELATED APPLICATION

This application claims the benefit of Singapore Patent Application No. 10201703634R, filed 3 May 2017.

### FIELD OF INVENTION

The present invention relates to a pesticide. In particular, the present invention relates to an oil-based pesticide formulation and an oil-based pesticide adjuvant, for use on plants and soils.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Damage to agricultural commodities (for example fruits and vegetables) by pests result in losses of approximately 30% of crops in the United States and up to 50% of crops worldwide. Agricultural crop losses are primarily caused by insect pest damage and plant diseases. Moreover, insects may also act as vectors of bacterial or viral plant diseases. Therefore, there is a need to develop and use pesticides to prevent crop losses.

Chemical pesticides have been developed and are commonly formulated as solid compositions such as water-dispersible, granular compositions and wettable powder compositions. Conventional solid compositions comprise an active compound, a mineral carrier, and a wetting agent and/or a dispersing agent (see e.g., U.S. Pat. Nos. 6,093,682; 5,595,749; 4,804,399). Pesticide active ingredients are also delivered in solid carriers such as kaolin, chalk, limestone, sodium and potassium alumina silicates, corn meals, sawdust, cellulose powder, activated charcoal and the like. However, such compositions often leave toxic residues which may have an extended impact on humans and the environment.

As such, liquid pesticides have been developed to overcome some of the disadvantages of solid pesticides. However, due to solubility limitations, liquid pesticides may be limited in the number and amount of components present in the liquid pesticide composition. The inability to solubilize high percentages of certain components in a liquid pesticide composition is a major disadvantage. Furthermore, incompatibilities between different components may exist, thereby making manufacture difficult or storage for extended time periods difficult.

Concentrated liquid pesticide compositions are advantageous because the high cost of shipping large volumes may be minimized. However, concentrated liquid pesticides may have the problem of phase stability because solid components may precipitate out or settle down, or liquid components may form separate liquid phases. As such, there is a need to develop a concentrated liquid pesticide that may effectively kill pests, and show improved phase stability over conventional concentrated liquid pesticides, even when diluted prior to use.

Furthermore, high percentages of certain components (for example oil) may lead to clogging of spray equipment, uneven and problematic application and reduced efficiency of application machinery. Importantly, crop damage may occur due to the use of high percentages of certain components. As such, there is a need to develop a liquid pesticide that may effectively kill pests, and avoid the afore-mentioned problems.

Accordingly, there is a need in the art for a pesticide to ameliorate the aforementioned problems.

The present invention seeks to address and/or ameliorate the problems in the prior art by providing an oil-based pesticide formulation and an oil-based pesticide adjuvant capable of controlling plant pests.

### SUMMARY OF INVENTION

According to an aspect of the present invention, there is pesticide nano-emulsion comprising: (a) a horticultural oil as an active ingredient; (b) a mixture of inert ingredients comprising: (i) an emulsifier; (ii) a stabilizer; and (iii) a surfactant; and (c) a solvent, wherein the horticultural oil is dispersed as droplets in the solvent to form the nano-emulsion.

In some embodiments, the droplets comprise an average size in the range of 50 nm to 350 nm.

In some embodiments, the droplets comprise an average size in the range of 100 nm to 250 nm.

In some embodiments, the stabilizer is in a concentration range of 0.5% to 5.0% w/w of the pesticide nano-emulsion.

In some embodiments, the mixture of inert ingredients further comprises a sticking agent in a concentration range of 0.25% to 3.00% w/w of the pesticide nano-emulsion.

In some embodiments, the horticultural oil is in a concentration range of less than 90% w/w of the pesticide nano-emulsion.

In some embodiments, the horticultural oil is in a concentration range of 20.0% to 70.0% w/w of the pesticide nano-emulsion and the mixture of inert ingredients is in a concentration of 30.0% to 80.0% w/w of the pesticide nano-emulsion.

In some embodiments, the horticultural oil is in an amount of 45.0% w/w of the pesticide nano-emulsion and the mixture of inert ingredients is in a concentration of 55.0% w/w of the pesticide nano-emulsion.

In some embodiments, the emulsifier is in a concentration range of 0.1% to 10.0% w/w of the pesticide nano-emulsion.

In some embodiments, the surfactant is in a concentration range of 0.5% to 30.0% w/w of the pesticide nano-emulsion.

In some embodiments, the solvent is at least 0.25% w/w of the pesticide nano-emulsion.

In some embodiments, the solvent comprises a first solvent and a second solvent, wherein the first solvent is water and the second solvent is at least 0.25% w/w of the pesticide nano-emulsion.

In some embodiments, the pesticide nano-emulsion is adapted to be diluted about 100 times to 800 times to form a dilute pesticide nano-emulsion.

In some embodiments, the horticultural oil is in a concentration range of 0.056% to 0.45% v/v of the dilute pesticide nano-emulsion.

In some embodiments, the stabilizer is in a concentration range of 0.001% to 0.017% v/v of the dilute pesticide nano-emulsion.

In another aspect of the present invention, there is a pesticide formulation comprising an effective amount of at least one pesticide and an adjuvant nano-emulsion comprising: (a) a horticultural oil as an active ingredient; (b) a mixture of inert ingredients comprising: (i) an emulsifier; (ii) a stabilizer; and (iii) a surfactant; and (c) a solvent, wherein the horticultural oil is dispersed as droplets in the solvent to form the adjuvant nano-emulsion.

### BRIEF DESCRIPTION OF THE DRAWINGS

The invention will now be described, by way of example only, with reference to the accompanying drawings, in which:

FIG. 1A and 1B illustrate the efficacy results of a formulation comprising an embodiment of the pesticide according to the invention in two amounts: (a) an amount of 4.8 fl.oz/25 gal, (b) an amount of 9.75 fl.oz/25 gal; in comparison with an existing pesticide in an amount of 7.0 fl.oz/25 gal on spider mite eggs (FIG. 1A) and spider mite adults and immatures (FIG. 1B), respectively; FIG. 1A illustrates the mean number of spider mite eggs per tomato leaf by the number of days after treatment (DAT). Pesticide 1 demonstrated significant reductions in egg numbers at both dilution rates relative to the untreated control for all dates except DAT 14. Pesticide 1 also showed comparable control to the industry standard pesticide C1-C2 across all dates except DAT28 where pesticide 1 maintained significantly lower egg numbers; FIG. 1B illustrates the mean number of spider mite adults and immatures per tomato leaf by the number of days after treatment (DAT). Pesticide 1 demonstrated significant reductions in egg numbers at both dilution rates relative to the untreated control for all dates. Pesticide 1 also showed non-significant differences to the industry standard pesticide C1-C2 across all dates.

### DESCRIPTION OF EMBODIMENTS OF THE INVENTION

Particular embodiments of the present invention will now be described with reference to the accompanying drawings. The terminology used herein is for the purpose of describing particular embodiments only and is not intended to limit the scope of the present invention. Other definitions for selected terms used herein may be found within the detailed description of the invention and applied throughout the description. Additionally, unless defined otherwise, all technical and scientific terms used herein have the same meanings as commonly understood by one or ordinary skill in the art to which this invention belongs.

Throughout the specification, unless the context requires otherwise, the word “comprise” or variations such as “comprises” or “comprising, will be understood to imply the inclusion of a stated integer or group of integers but not the exclusion of any other integer or group of integers.

Furthermore, throughout the specification, unless the context requires otherwise, the word “include” or variations such as “includes” or “including” will be understood to imply the inclusion of a stated integer or group of integers but not the exclusion of any other integer or group of integers.

As used herein, the term “about” typically means +/−5% of the stated value, more typically +/−4% of the stated value, more typically +/−3% of the stated value, more typically +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as a limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. Ranges are not limited to integers, and can include decimal measurements where applicable. This applies regardless of the breadth of the range.

As used herein, the term “concentrate” refers to a formulation that can be diluted to form the use solution. The concentrate, for example, may be easier and less expensive to transport compared to the diluted solution.

As used herein, the term “highly concentrated formulation” refers to a formulation that needs to be significantly diluted so that an appropriate desired dosage/usage concentration may be achieved.

As used herein, the terms “emulsion” and “nano-emulsion” are used interchangeably and refer to a mixture of two immiscible substances. One substance (the dispersed phase) may be dispersed in the other (the continuous phase). For instance, it will be appreciated in a pesticide formulation of the present invention, the horticultural oil exists as minute droplets (which include but are not limited to micro- and nano-droplets) or micelles dispersed in the solvent, where the oil and solvent are not miscible in one another. The oil droplets may be evenly and homogenously distributed in the solvent although it will be appreciated that there can be uneven distribution of the oil droplets in the solvent, for example if the pesticide emulsion is left to stand for a substantial period of time. As used herein, the term “nano-emulsion” refers to an emulsion having oil droplet sizes in a range of about 50 nm to about 400 nm.

The present invention relates to a pesticide formulation that can be a liquid, for plants and/or soil which delivers aphysical mode of action. The various components of the pesticide formulation may be multi-functional. For instance, a particular component can be an emulsifier and a sticking agent; or a stabilizer and an emulsifier. As an illustration, a polysaccharide or a derivative thereof may be both a stabilizer and an emulsifier, and therefore regarded as two inert ingredients for the purpose of this invention. Consequently, the present invention can be used to control the growth and spread of pests and plant diseases. Examples of pests that may be controlled and/or eliminated by the pesticide formulation of the present invention, include but are not limited to, insects (e.g., mosquitoes, flies, wasps, ants, woodlice, locusts, grasshoppers, aphids, chinch bugs, citrus rust mites, spider mites, armored and soft scales, mealy bugs, white-flies, leaf-rollers, leaf miners, fungus gnats, nematodes, sharpshooters and thrips), fungi, or a combination thereof. Plants diseases include but are not limited to greasy spot, silver scurf and powdery mildew.

An aspect of the present invention is a pesticide nano-emulsion comprising: (a) a horticultural oil as an active ingredient; (b) a mixture of inert ingredients comprising (i) an emulsifier; (ii) a stabilizer; and (iii) a surfactant; and (c) a solvent, wherein the horticultural oil is dispersed as droplets in the solvent to form the nano-emulsion. The droplets may have an average size in the range of about 2 nano-metres (nm) to about 400 nm. In the present invention, the horticultural oil is not a carrier, such as, for other active ingredients. Surprisingly, the inventors found that no other active ingredients were necessary as the horticultural oil was found to be an effective active ingredient, even at relatively low concentrations. The term “relatively low concentrations” refers to a horticultural oil concentration that is lower than prior art horticultural oil-based pesticides that typically comprise horticultural oil at a concentration range of about 90% to 98% w/w of the formulation. In addition, no or negligible toxic residues are left over. As such, the horticultural oil-based pesticide of the present invention has low toxicity and low impact on non-target beneficial insects, humans and the environment. In contrast, prior art pesticides often leave toxic residues which may have an extended impact on humans and the environment.

The pesticide nano-emulsion may be diluted before use, or may be utilized directly as a concentrated formulation (i.e. a “concentrate”), depending on the application and requirements. Advantageously, the pesticide nano-emulsion is phase stable and can effectively kill pests at least as well as conventional pesticides. Preferably, the horticultural oil droplets and solvent are not miscible in one another. The oil droplets are adapted to associate and/or interact with the emulsifier, stabilizer, surfactant and/or other components in the pesticide nano-emulsion, thereby forming micelles. It will be appreciated that if the horticultural oil comprises both a hydrophobic and hydrophilic group, the horticultural oil can itself form micelles—such micelles are also adapted to associate and/or interact with the emulsifier, stabilizer, surfactant and/or other components in the pesticide nano-emulsion. Accordingly, the term “droplet” used throughout the specification herein includes but is not limited to micelles.

In some embodiments, the horticultural oil used contains little to no volatile organic compounds and the primary mode of action is through suffocation of arthropods and plant pathogens where the physical effects of the oil is the active ingredient because the oil coating prevents respiration and kills the pest. Examples of oils that contain little to no volatile organic compounds include but are not limited to vegetable oils such as olive oil, soybean oil, palm oil, cottonseed oil, corn oil, coconut oil, peanut oil and canola oil.

In some embodiments, the droplets have an average size of about 50 nm to about 400 nm, about 50 nm to about 350 nm, about 50 nm to about 300 nm, about 50 nm to about 250 nm, about 50 nm to about 200 nm, about 50 nm to about 150 nm, about 100 nm to about 350 nm, about 100 nm to about 300 nm, about 150 nm to about 350 nm, about 150 nm to about 250 nm, about 200 nm to about 350 nm, about 250 nm to about 350 nm, and even more preferably about 100 nm to about 250 nm. The size of the oil droplets is advantageous for effectively penetrating insect pests while concurrently reducing plant phytotoxicity since the droplets do not block stomata. Even distribution of the oil can also be maintained for extended periods of time without agitation. A stable formulation with an even oil distribution allows greater efficacy against pests compared to conventional oil pesticide products, even when the oil in the present invention is at lower concentrations compared to conventional pesticide formulations. At the same time, problems such as clogging of spray equipment, uneven and problematic application, reduced efficiency of application machinery and crop damage may be reduced or avoided.

Advantageously, the pesticide of the present invention delivers a physical mode of action, whereby a layer of oil may form on the plant and suffocate pests and/or interfere with or disrupt their normal biological and/or physiological functions. More advantageously, pests would not likely develop resistance to the horticultural oil-based pesticide of the present invention. More advantageously, the horticultural oil-based pesticide of the present invention has low toxicity and low impact on non-target beneficial insects because of minimal or absence of any residual effect by the formulations of the present invention. As such, the pesticide of the present invention may selectively target pests while causing no or minimal harm to beneficial insects.

The afore-mentioned advantages arise because of nano-emulsification of the horticultural oil, which is present in the pesticide as an active ingredient for killing a pest. In particular, the nano-emulsions may improve the delivery and distribution of the oil droplets when the pesticide is sprayed on the plant, such as the surface(s) of the plant, because the relatively small size of the droplets as described above substantially increases the number of droplets, thereby increasing the probability of the horticultural oil contacting the pest. Upon contacting the pest, the horticultural oil may suffocate pests and/or interfere with or disrupt their normal biological and/or physiological functions with minimal or negligible toxicity to the plant. In addition, there may be selective targeting of pests, such that non-target beneficial insects are not harmed or minimally harmed.

Furthermore, the reduced droplet size of the pesticide may increase the surface area(s) of the plant that is contacted by the horticultural oil, thereby increasing the efficacy of the pesticide.

In various embodiments, the mixture of inert ingredients is in a concentration of about 30.0% to about 80.0% w/w of the pesticide nano-emulsion. As mentioned above, the mixture of inert ingredients comprises an emulsifier, a stabilizer, and a surfactant. When the mixture of inert ingredients is in a concentration of about 30.0% to about 80.0% w/w of the pesticide nano-emulsion, the horticultural oil is in a concentration range of about 20.0% to about 70.0% w/w of the pesticide nano-emulsion.

In various embodiments, the stabilizer may comprise a polysaccharide or a derivative thereof. The stabilizer may be in a concentration range of about 0.5% to 5.0% w/w of the pesticide nano-emulsion. This concentration range of the stabilizer is advantageous in the maintenance of the size and dispersibility of the droplets in the pesticide nano-emulsion. The stabilizer may have emulsifying properties and may be considered a co-emulsifier.

In some embodiments, the mixture of inert ingredients of the pesticide nano-emulsion further comprises a sticking agent in a concentration range of about 0.025% to about 1.500% w/w of the pesticide nano-emulsion. In some embodiments, the sticking agent is in a concentration range of about 0.25% to 3.00% w/w of the pesticide nano-emulsion. The sticking agent preferably comprises solid particles that are adapted to achieve a Pickering emulsion of the pesticide nano-emulsion. The sticking agent may have emulsifying properties and may be considered a co-emulsifier.

In various embodiments, nano-emulsification of the horticultural oil facilitates a reduced oil concentration sufficient for controlling pests, while mitigating the risk of the horticultural oil damaging the plants. Preferably, the horticultural oil is in a concentration range of less than about 90.0% w/w of the pesticide nano-emulsion, less than about 50.0% w/w of the pesticide nano-emulsion, less than about 1.0% w/w of the pesticide nano-emulsion. In various embodiments, the horticultural oil is in a concentration range of about 0.15% to about 85.0% w/w of the pesticide nano-emulsion, about 0.15% to about 50.0% w/w of the pesticide nano-emulsion, about 5.0% to about 85.0% w/w of the pesticide nano-emulsion, about 5.0% to about 80.0% w/w of the pesticide nano-emulsion, about 5.0% to about 70.0% w/w of the pesticide nano-emulsion, about 5.0% to about 60.0% w/w of the pesticide nano-emulsion, about 5.0% to about 50.0% w/w of the pesticide nano-emulsion, about 10.0% to about 80.0% w/w of the pesticide nano-emulsion, about 10.0% to about 70.0% w/w of the pesticide nano-emulsion, about 10.0% to about 60.0% w/w of the pesticide nano-emulsion, about 10.0% to about 50.0% w/w of the pesticide nano-emulsion, more preferably about 5.0% to about 80.0% w/w of the pesticide nano-emulsion, and even more preferably, about 5.0% to about 45.0% w/w, about 5.0% to about 50.0% w/w or about 10.0% to about 50.0% w/w of the pesticide nano-emulsion.

In some embodiments, the emulsifier is in a concentration range of about 0.05% to about 10.0% w/w pesticide nano-emulsion. In some embodiments, the emulsifier is in a concentration range of about 0.1% to about 10.0% w/w of the pesticide nano-emulsion. In some embodiments, the emulsifier does not comprise a polysaccharide or a derivative thereof.

Preferably, the surfactant is in a concentration range of about 0.5% to about 30.0% w/w of the pesticide nano-emulsion.

In contrast, prior art horticultural oil-based pesticide concentrates typically comprise horticultural oil at a concentration range of about 90% to 98% w/w of the formulation, and emulsifiers and surfactants at a concentration range of about 2% to 10% w/w of the formulation, to produce a stable emulsified concentrate formulation. As such, the pesticide nano-emulsion of the present invention may advantageously effectively kill pests at least as well as prior art horticultural oil-based pesticide concentrates at lower concentrations. Furthermore, the prior art horticultural oil-based pesticides use a horticultural oil with a relatively large droplet size, thereby negatively affecting the physiology of the plants, such as causing leaf burning, reduced photosynthesis, reduced transpiration and reduced flowering and fruit set. As such, the pesticide nano-emulsion of the present invention may exhibit reduced phytotoxicity because the relatively small droplet size as described above may lead to a reduced likelihood in blocking transpiration across leaf surfaces and through the stomata, thereby leading to unimpeded transpiration, avoidance or minimization of stunted growth and/or avoidance or minimization of reduced crop yield.

In some embodiments, the solvent is at least 0.25% w/w of the pesticide nano-emulsion. The solvent may comprise a first solvent and a second solvent, wherein the first solvent is water and the second solvent is at least 0.25% w/w of the pesticide nano-emulsion.

The pesticide nano-emulsion as described above may be directly used as a concentrated formulation (i.e. a “concentrate”) or adapted to be diluted. In some embodiments, the dilution factor is about 150 times to 700 times to form a dilute pesticide nano-emulsion. In some embodiments the dilution factor is about 100 times to 800 times to form a dilute pesticide nano-emulsion. The pesticide nano-emulsion of the present invention may exhibit dilution thickening behavior. In particular, the viscosity of the pesticide nano-emulsion may initially increase with increasing dilution, reach a maximum value and then decrease with further dilution. The increasing viscosity with increasing dilution may correspond to an increasing concentration of stabilizer, such as a water soluble polysaccharide, as the concentration of the other components, such as a surfactant and/or a salt component, decreases with increasing dilution.

Another aspect of the present invention is a dilute pesticide emulsion comprising (a) a horticultural oil as an active ingredient; (b) a mixture of inert ingredients comprising (i) an emulsifier; (ii) a stabilizer; and (iii) a surfactant; and (c) a solvent, wherein the horticultural oil is dispersed as droplets in the solvent to form the dilute pesticide nano-emulsion. In some embodiments the droplets have an average size in the range of about 2 nm to about 400 nm. In some embodiments the droplets have an average size of about 50 nm to about 350 nm. The various components of the dilute pesticide emulsion may be multi-functional. For instance, a particular component can be an emulsifier and a sticking agent; or a stabilizer and an emulsifier. As an illustration, a polysaccharide or a derivative thereof may be both a stabilizer and an emulsifier, and therefore regarded as two inert ingredients for the purpose of this invention.

In the dilute pesticide nano-emulsion, the horticultural oil droplets and solvent are not miscible in one another. The oil droplets are adapted to associate and/or interact with the emulsifier, stabilizer, surfactant and/or other components in the pesticide nano-emulsion, thereby forming micelles. It will be appreciated that if the horticultural oil comprises both a hydrophobic and hydrophilic group, the horticultural oil can itself form micelles—such micelles are also adapted to associate and/or interact with the emulsifier, stabilizer, surfactant and/or other components in the pesticide nano-emulsion. In some embodiments, the droplets have an average size of about 50 nm to about 400 nm, about 50 nm to about 350 nm, about 50 nm to about 100 nm, about 100 nm to about 250 nm. The size of the oil droplets is advantageous for effectively penetrating insect pests while concurrently reducing plant phytotoxicity since the droplets do not block stomata. Even distribution of the oil can also be maintained for extended periods of time without agitation. A stable formulation with an even oil distribution allows greater efficacy against pests compared to conventional oil pesticide products, even when the oil in the present invention is at lower concentrations compared to conventional dilute pesticide formulations. At the same time, problems such as clogging of spray equipment, uneven and problematic application, reduced efficiency of application machinery and crop damage may be reduced or avoided.

Known oil-based liquid pesticide concentrates are typically diluted to an oil concentration of 1.0% to 2.0% w/w. At such an oil concentration, there is a risk of negative secondary effects including plant damage (phytotoxicity) that may occur depending on plant type, climatic factors, and the quality and stability of oil-water dilution mixtures. In particular, phytotoxicity may arise due to direct damage of leaf epidermal cells from concentrated oil droplets or reduced photosynthesis from blockage of plant stomata. Damage to plants may also arise because diluted oil-based pesticides are inherently unstable and thus require constant energy input by way of agitation to maintain as diluted oil dispersions. Insufficient agitation frequently results in poor distribution of oil in water/solvent due to the coalescence of the oil droplets, thereby forming larger oil droplets. The larger oil droplets result in uneven distribution of oil when sprayed on leaf surfaces, which in turn, may cause variable performance against target pests and increase the risk of phytotoxicity. While the horticultural oil-based pesticide of the present invention is capable of being used at conventional oil concentrations and efficiently kill pests at least as well as conventional formulations, the horticultural oil-based pesticide formulation of the present invention is advantageously capable of effectively killing pests at even lower dilutions of oil concentrations of about 0.056% to about 0.5% v/v, about 0.056% to about 0.45% v/v, about 0.15% to about 0.5% v/v, or about 0.15% to about 0.3% v/v of the pesticide nano-emulsion. Furthermore and more importantly, the risk of phytotoxicity is reduced with less than 1% v/v of horticultural oil in the diluted formulation.

In various embodiments, the stabilizer may comprise a polysaccharide or a derivative thereof. Preferably, the stabilizer is in a concentration range of about 0.001% to about 0.017% v/v of the dilute pesticide nano-emulsion. This concentration range of the stabilizer is advantageous in the maintenance of the size and dispersibility of the droplets in the pesticide nano-emulsion. The stabilizer may have emulsifying properties and may be considered a co-emulsifier.

Preferably, the dilute pesticide nano-emulsion comprises a sticking agent. The sticking agent preferably comprises solid particles that are adapted to achieve a Pickering emulsion of the pesticide nano-emulsion. The sticking agent may have emulsifying properties and may be considered a co-emulsifier.

Preferably, the horticultural oil is in a concentration range of about 0.01% to about 0.32% v/v of the dilute pesticide nano-emulsion, more preferably 0.01% to about 0.27% v/v of the dilute pesticide nano-emulsion, and even more preferably, 0.01% to about 0.15% v/v of the dilute pesticide nano-emulsion.

Preferably, the emulsifier does not comprise a polysaccharide or a derivative thereof.

Preferably, the dilute pesticide emulsion comprises a surfactant.

Another aspect of the present invention is a pesticide formulation comprising an effective amount of at least one pesticide and an adjuvant nano-emulsion comprising (a) a horticultural oil as an active ingredient; (b) a mixture of inert ingredients comprising (i) an emulsifier; (ii) a stabilizer; and (iii) a surfactant; and (c) a solvent, wherein the horticultural oil is dispersed as droplets in the adjuvant nano-emulsion. The droplets may have an average size in the range of about 50 nm to about 350 nm.

Another aspect of the present invention is a pesticide formulation comprising an effective amount of at least one pesticide and a dilute adjuvant nano-emulsion comprising (a) a horticultural oil as an active ingredient; (b) a mixture of inert ingredients comprising (i) an emulsifier; (ii) a stabilizer; and (iii) a surfactant; and (c) a solvent, wherein the horticultural oil is dispersed as droplets in the dilute adjuvant nano-emulsion. The droplets may have an average size in the range of about 50 nm to about 350 nm.

The pesticide nano-emulsion, dilute pesticide nano-emulsion and pesticide formulations can be applied to plants, soil and/or an intended area by means known in the art, which include but are not limited to spraying, misting, aerosolising and/or direct pouring. The various components of the pesticide nano-emulsion, dilute pesticide nano-emulsion and pesticide formulations may be multi-functional. For instance, a particular component can be an emulsifier and a sticking agent; or a stabilizer and an emulsifier. As an illustration, a polysaccharide or a derivative thereof may be both a stabilizer and an emulsifier, and therefore regarded as two inert ingredients for the purpose of this invention. The present invention can be used on a variety of plants which include but are not limited to ornamental plants such as camellia and lilac; grains and field crops such as oat, barley, wheat, rye, cotton, tobacco, maize, peanut or soybean; fruits such as blueberry, cranberry, strawberry, banana, peach, nectarine, apple, pear, orange, lemon, grapefruit, pecan, avocado, grape or tomato; vegetables such as broccoli, cabbage, cauliflower, kale, lettuce, spinach, celery, onion, or asparagus. The present invention may be applied to seeds such as almonds or coffee beans, corms, bulbs, flowers such as hops, stems, leaves, fruits of plants, aquatic agriculture plants, root and tuber crops.

The oil-based pesticide formulations and oil-based pesticide adjuvants of the present invention can comprise other additives, which include wetting and spreading agents which improve the spread and area coverage of an applied formulation on a surface.

Horticultural Oils

The pesticide nano-emulsion, dilute pesticide nano-emulsion and formulations of the present invention comprise a horticultural oil. The horticultural oil preferably exists as droplets in the formulations of the present invention. Due to the hydrophobic nature of oils, such droplets are preferably associated and/or interact with the emulsifier, surfactant, stabilizer and/or sticking agent in the formulation, thereby forming micelles. It will be appreciated that if the horticultural oil comprises both a hydrophobic and hydrophilic group, the horticultural oil can itself form micelles that are associated and/or interact with the emulsifier, surfactant, stabilizer and/or sticking agent in the formulation. The size (measurement of their diameters) of the droplets can range from a few nanometres to a few micrometres, preferably about 2 nm to about 400 nm, more preferably 50 nm to about 400 nm, and even more preferably about 50 nm to about 100 nm. The size of the droplets may be affected by the synthesis method, for example, the rate of agitation to disperse the hydrophobic horticultural oil in the solvent. In various embodiments, higher rates of agitation may form droplets of smaller sizes.

Horticultural oils as used in the present invention are effective as pesticides for pest control. In particular, the horticultural oils may be capable of killing, destroying, and/or controlling pests and/or their growth and spread. When used, a layer of oil on the plant and/or soil suffocates pests and/or interferes with their normal biological functions.

Horticultural oils include dormant and summer oils (also known as superior oils) which are hydrophobic or substantially hydrophobic. Dormant oils are usually used for cool-season pest control that overwinter on plants while summer oils are usually used during the growing season.

The horticultural oils used in the present invention are plant (including vegetable), hydrocarbon or animal fat oils that are typically processed into emulsified concentrate formulations for diluted spray application to growing or post-harvest agricultural crops for the purpose of controlling arthropod and fungal crop pests. The typical oils used include ultra refined paraffin oils and vegetable oils such as soybean, palm oil, cottonseed or canola oil. These oils contain little to no volatile organic compounds and the primary mode of action is through suffocation of arthropods and plant pathogens where the physical effects of the oil is the active ingredient because the oil coating prevents respiration and kills the pest. Examples of oils that contain little to no volatile organic compounds include but are not limited to vegetable oils such as olive oil, soybean oil, palm oil, cottonseed oil, corn oil, coconut oil, peanut oil and canola oil.

Volatile plant oils, on the other hand, are oils that have in recent years been used for their pesticidal properties. These oils are highly aromatic due to the presence of various volatile organic compounds (VOCs) often called secondary plant chemicals. Many of the volatile compounds have shown biocidal activity against a wide range of disease and pest types and are thought to act as plant defense chemicals. They have been used in various applications ranging from medicine to structural and agricultural pest control. Common examples of volatile plant oils include rosemary, garlic, clove, neem and eucalyptus oils. The primary difference between the horticultural oils used in the present invention and the volatile plant oils used in the prior art is the difference in the primary mode of action. Volatile plant oils rely on the toxic effects of the VOCs while horticultural oils use a physical mode of action.

Nano-emulsions are relatively new formulation technologies for oil in water (o/w) emulsion systems. Nano-emulsions are typically defined by reduced oil droplet sizes to a range of 50 nm to 400 nm whereas conventional o/w emulsions are typically >400 nm. The advantage of nano-emulsions over conventional emulsion formulations is that the smaller droplet sizes can improve the distribution and targeting of the oil droplets to a target. Nano-emulsions have been used as a way to increase the efficiency of delivering the oil miscible active ingredient in a volatile plant oil to a specific target in various industrial, medicinal and agricultural applications. However, the primary role of the oil in those applications has been as a carrier for the oil miscible active ingredients. In agriculture, for example, nano-emulsion formulations have been used to enhance the efficacy of oil miscible pesticide active ingredients to increase pest mortality at a given dosage, or as a way to reduce the required dosage needed to achieve the desired level of control.

The present invention, on the other hand, is using nano-emulsion technology in an entirely different way to improve the efficacy of horticultural oils where the oils operate not as a carrier for oil miscible active ingredients, rather, where the physical properties of the oil droplets themselves operate as the active ingredient.

Viscosity impacts the flow and spread of the horticultural oil on surfaces. Lighter oils spread more evenly while heavier oils tend to bead up more on surfaces.

Horticultural oils can include synthetic oils and semi-synthetic oils. Preferably, the horticultural oil used in the compositions/formulations of the present invention is edible. One or more horticultural oils may be used in the compositions/formulations of the present invention.

Emulsifiers

The pesticide nano-emulsion, dilute pesticide nano-emulsion and formulations of the present invention comprise an emulsifier. The emulsifier helps an emulsion form, or keeps an emulsion from separating into its constitutive phases. An emulsifier comprises a hydrophilic head that interacts with a hydrophilic solvent, and a hydrophobic tail which interacts with the hydrophobic horticultural oil. In an emulsion, the emulsifier positions at the oil-solvent interface and maintains the separation of the oil and solvent by reducing surface tension.

Emulsifiers include but are not limited to acrylate, acrylate copolymer, agar, alginic acid and its derivatives, alginate derivatives (includes but is not limited to ammonium alginate, calcium alginate, potassium alginate, sodium alginate and propylene glycol alginate), arabic gum, arabinogalactan, beta-glucan, carrageenan, cellulosic polymer, ceramide, chitin, dextran, diutan gum, furcellaran, fucoidan, gellan gum, glycogen, guar gum, ghatti gum, karaya gum, laminarin, lecithin, lignin locust bean gum, methacrylate, methyl methacrylate, modified starch, pectin, psyllium, polyvinylpyrrolidone, rhamsan gum, saponin and its derivatives (includes but is not limited to latex saponin), scleroglucan, sulfonic acid, starch, starch hydroxyethyl ether, starch dextrins, tragacanth gum and xanthan gum. The cellulosic polymers include but are not limited to bacterial cellulose, carboxymethyl cellulose, ethyl cellulose, ethyl-hydroxyethylcellulose, hydroxyethyl cellulose, hydroxypropyl cellulose, hydroxypropyl methylcellulose, methyl cellulose, microparticulate cellulose and sodium carboxymethyl cellulose.

Preferably, the emulsifier does not comprise or is not a polysaccharide or a derivative thereof, particularly if the stabilizer comprises a polysaccharide. However in various embodiments, it is possible for both stabilizer and emulsifier to comprise polysaccharides, i.e. there will be two polysaccharides in the formulation. In such embodiments, it is preferable that the two polysaccharides are different polysaccharides.

Stabilizers

The pesticide nano-emulsion, dilute pesticide nano-emulsion and formulations of the present invention comprise a stabilizer. The stabilizer stabilizes an emulsion by maintaining the homogenous dispersion of the droplets of the horticultural oil in the solvent and preventing phase separation of the horticultural oil and solvent, i.e. the dissociation of the droplets to form a separate layer of horticultural oil and solvent. Stabilizers can have emulsification properties and certain stabilizers can be used as emulsifiers or co-emulsifiers. Preferably, the stabilizers in the compositions/formulations of the present invention are not true emulsifiers and are mainly used to stabilize an emulsion.

Stabilizers include but are not limited to proteins, polysaccharides and derivatives thereof. In particular, stabilizers include but are not limited to acacia gum, agar, alginic acid and its derivatives, alginate derivatives (includes but is not limited to ammonium alginate, calcium alginate, potassium alginate, sodium alginate and propylene glycol alginate), arabic gum, carboxymethylcellulose, carrageenan, gelatine, glycerol, glycogen, guar gum, karaya gum, locust bean gum, mannitol, pectin and its derivatives, saponin or its derivatives, tara gum, tragacanth gum and xanthan gum.

Preferably, the stabilizers used in the compositions/formulations of the present invention comprise polysaccharides or derivatives thereof. More preferably, the stabilizers used in the compositions/formulations of the present invention are polysaccharides or derivatives thereof. Polysaccharides are polymeric carbohydrate molecules of chains of monosaccharide units (i.e. sugar) bound by glycosidic bonds. Polysaccharides include linear and branched structures, and can be homogenous repeats of one type of monosaccharide unit (homopolysaccharides) or heterogenous repeats of more than one type of monosaccharide units in random or non-random arrangements (also known as heteropolysacchrides). As used throughout the specification herein, polysaccharides and derivatives thereof include structures having more than three monosaccharide units and therefore include but are not limited to oligosaccharides. Polysaccharide derivatives refer to polysaccharide chains of monosaccharide units wherein one or more of the side branches of one or more of the monosaccharide units are modified, for example, such side branches may contain hydroxyl, amino and/or carboxylic acid groups. Advantageously, polysaccharides can modify the viscosity of the compositions/formulations of the present invention. When polysaccharides are used in combination with solid particles, e.g. clay particles and the emulsion comprises droplets having an average size of about 2 nm to about 400 nm, the emulsion may be maintained without separating into its constitutive phases even when diluted. As such, coalescence and phase separation is prevented and dilute solutions can remain as suspensions for extended periods of time of more than 30 days.

Preferably, the stabilizers in the compositions/formulations of the present invention include but are not limited to acacia gum, agar, alginic acid and its derivatives, alginate derivatives (includes but is not limited to ammonium alginate, calcium alginate, potassium alginate and sodium alginate and propylene glycol alginate), arabic gum, carboxymethylcellulose, carrageenan, glycogen, guar gum, karaya gum, saponin or its derivative, locust bean gum, pectin and its derivatives, tara gum, tragacanth gum or xanthan gum.

Polysaccharides can also be thickening agents and gelling agents in the compositions/formulations of the present invention.

Solvents

The pesticide nano-emulsion, dilute pesticide nano-emulsion and formulations of the present invention comprise a solvent. Solvents serve as a diluent in the present invention, and to dissolve or partially dissolve and disperse or partially disperse the components of the compositions/formulations of the present invention. The solvent can comprise one or more of water, an aliphatic hydrocarbon, an aromatic hydrocarbon, a ketone, an alcohol (straight-chained or branched), an ester, an amide or an ether. The aliphatic hydrocarbon can comprise linear or branched alkanes, linear or branched alkenes (olefins), and/or cyclic alkanes (naphthenes). Preferably, the solvent is hydrophilic or substantially hydrophilic. More preferably, the solvent is water.

When the solvent is water, a stabilized oil-in-water emulsion may be formed by first constructing a micro-emulsion formulation comprising a polysaccharide or other polymer, and solid particles. The micro-emulsion formulation may be formed by blending of these various components. The polysaccharide or other polymer acts as a viscosity modifier that operates to form micro-droplets to maintain the distribution of oil globules of the dispersion phase, thereby stabilizing the emulsion. In addition, the solid particles act as co-emulsifying agents to further stabilize the formulation in a Pickering style micro-emulsion. As such, the polysaccharide or other polymer, and solid particles act cooperatively to stabilize the formulation. The micro-droplet formulation (i.e. micro-emulsion formulation) is thereafter subjected to a high-shear mixer to form a nano-droplet emulsion that further reduces oil globule size and enhances stabilization of the emulsion. Consequently, an emulsion formulation comprising oil droplets having an average size in the range of about 2 nm to about 400 nm may form. Advantageously, the nano-emulsion formulation in the particular particle size range is both thermodynamically and kinetically stable. This may lead to better penetration of insects and reduced phytotoxicity. Furthermore, the emulsion formulation produces a pesticide formulation with a long shelf life of more than two years that can be easily diluted to the desired end-use concentration.

Preferably, the solvent is an ester selected from the group comprising butyl acetate, dipropylene glycol methyl ether acetate and ethyl acetate, an alcohol selected from the group comprising ethanol, isobutanol, isopropanol, methanol, phenol and propylene glycol, or mixtures thereof.

One or more solvents may be used to dissolve and/or disperse the components of the compositions/formulations of the present invention. The solvent used to dilute the pesticide nano-emulsion to a dilute pesticide nano-emulsion can be different from the solvent in the pesticide nano-emulsion.

Surfactants

The pesticide nano-emulsion, dilute pesticide nano-emulsion and formulations of the present invention may comprise one or more surfactants. Surfactants are capable of reducing the surface tension of the horticultural oil in the solvent. Surfactants include but are not limited to an anionic, non-ionic, cationic, or amphoteric surfactant, block polymer or polyelectrolyte.

Anionic surfactants include but are not limited to alkali, alkaline earth or ammonium salts of sulfates, sulfonates, phosphates or carboxylates. Examples of sulfates are sulfates of fatty acids and oils, of ethoxylated alkylphenols, of alcohols, of ethoxylated alcohols, and of fatty acid esters. Examples of sulfonates are alkylarylsulfonates, diphenylsulfonates, alpha-olefin sulfonates, sulfonates of fatty acids and oils, sulfonates of ethoxylated alkylphenols, sulfonates of dodecyl- and tridecylbenzenes, sulfonates of naphthalenes and alkylnaphthalenes, sulfosuccinates and sulfosuccinamates. Examples of phosphates are phosphate esters. Examples of carboxylates are alkyl carboxylates, carboxylated alcohols and alkylphenol ethoxylates.

Non-ionic surfactants include but are not limited to alkoxylates, N-alkylated fatty acid amides, amine oxides, esters and sugar-based surfactants. Examples of alkoxylates are compounds such as alcohols, alkylphenols, amines, amides, arylphenols, fatty acids and fatty acid esters which have been alkoxylated. Ethylene oxide and/or propylene oxide may be employed for the alkoxylation, with ethylene oxide being the preferred choice. Examples of N-alkylated fatty acid amides are fatty acid glucamides and fatty acid alkanolamides. Examples of esters are fatty acid esters, glycerol esters and monoglycerides. Examples of sugar-based surfactants are sorbitans, ethoxylated sorbitans, sucrose and glucose esters and alkylpolyglucosides.

Examples of suitable cationic surfactants are quaternary surfactants, for example quaternary ammonium compounds with one or two hydrophobic groups, and salts of long-chain primary amines.

Amphoteric surfactants include but are not limited to alkylbetains and imidazolines. Block polymers include but are not limited to block polymers of the A-B and A-B-A types comprising blocks of polyethylene oxide and polypropylene oxide, and of the A-B-C type comprising alkanol, polyethylene oxide and polypropylene oxide.

Polyelectrolytes include but are not limited to polyacids and polybases. Examples of polyacids are alkali salts of polyacrylic acid. Examples of polybases are polyvinylamines and polyethyleneamines.

The ability of surfactants to reduce the surface tension of the minute droplets/micelles depends on the molecular structure of the surfactant. Specifically, the hydrophilic-lipophilic balance (HLB) determines whether the surfactant is soluble in water and whether water-immiscible liquid droplets can be stabilized (i.e. emulsified) in water. The HLB value of a surfactant indicates the overall polarity of the molecule, and is in the range of 1 to 40, with the most common commercial surfactants having an HLB value of 1 to 20. The HLB value increases with increasing hydrophilicity. Surfactants with HLB values of 0 to 7 are considered lipophilic, surfactants with HLB values of 12 to 20 are considered hydrophilic, and surfactants with HLB values of 7 to 12 are considered intermediate. Preferably, a non-ionic surfactant is used in the present invention, wherein the non-ionic surfactant can have an intermediate HLB value, depending on factors such as chain length and degree of ethoxylation. Preferably, the surfactant comprises one or more of a non-ionic surfactant selected from the group comprising linear alcohol ethoxylates such as polyoxyethylene lauryl ether, phenol ethoxylates such as nonylphenol ethoxylate, octylphenol ethoxylate and dodecylphenol ethoxylate, polyoxyethylene sorbitan fatty acid esters such as polysorbate 20, sorbitan fatty acid esters such as sorbitan monostearate, sucrose fatty acid esters such as sucrose stearate, and vegetable oil surfactants such as polyoxyethylene castor oil or derivatives thereof.

Sticking/Adhesion Agents

The pesticide nano-emulsion, dilute pesticide nano-emulsion and formulations of the present invention may comprise one or more sticking and adhesion agents. Sticking and adhesion agents can be used to help hold the composition/formulation of the present invention onto surfaces, for example, leaf surfaces, for extended periods of time. In particular, the sticking and adhesion agents can increase the adhesion of the droplets to the surface on which the compositions/formulations of the present invention are applied. Thickening agents which improve the viscosity of a composition/formulation can also be sticking agents, however sticking agents may not be thickening agents, i.e. they do not improve the viscosity of a composition/formulation. Increased adhesion of the droplets on applied surfaces increases resident time which improves the effect on pests by the formulation. Charged sticking and adhesion agents can also improve penetration of the droplets into pests for improved killing of such pests.

Sticking and adhesion agents can be charged or uncharged. Charged sticking agents include molecules that are positively and/or negatively charged. Preferably, the sticking agents are positively charged to improve adhesion of the minute droplets/micelles to negatively charged portions of plants, e.g. leaves.

Sticking and adhesion agents include but are not limited to clay, cellulose, charcoal, diatomaceous earth, natural or synthetic silicates, titanium dioxide, magnesium silicate, aluminum silicate, talc, pyrophyllite clay, silica, attapulgite clay, chalk, limestone, calcium carbonate, bentonite clay or Fuller's earth. Preferably the sticking and adhesion agent is one or more of cellulose, chalk, charcoal, diatomaceous earth, kaolinite, limestone or silica.

Sticking and adhesion agents can have other properties such as wetting and spreading properties. Sticking and adhesion agents may also have emulsifying properties and may be considered co-emulsifiers.

Pesticides

The pesticide nano-emulsion and its dilute formulation can be used as adjuvants in pesticide compositions/formulations. Therefore the pesticide nano-emulsion and its diluted form can be used and/or mixed together with one or more chemical and/or biological pesticides as active ingredients to form a pesticide composition/formulation. When used as an adjuvant, the pesticide nano-emulsion can be considered an adjuvant emulsion concentrate while the dilute pesticide nano-emulsion can be considered a dilute adjuvant nano-emulsion.

As used throughout the specification herein and when the pesticide nano-emulsion and/or its dilute formulation is used as adjuvants in pesticide compositions/formulations, a “pesticide” refers to a chemical or biological agent that kills, destroys and/or controls pests and/or their growth and spread. Examples of pesticides which can be combined with the pesticide nano-emulsion and/or its dilute formulation include, but not limited to, fungicides, herbicides, insecticides, miticides, bactericides, nematicides, and algaecides. Those skilled in the art will know the many types and classes of pesticides available.

In various embodiments, there can be more than one oil in the pesticide composition/formulation, for example, an adjuvant nano-emulsion comprising a vegetable oil (as the horticultural oil component) and an essential oil (as a pesticide component).

### EXAMPLES

Example 1

A pesticide nano-emulsion in accordance with embodiments of the present invention was developed for the control of insect and disease pests in wine grape (Pesticide 1). Pesticide 1 is a soybean oil-based pesticide comprising 45% w/w soybean oil and 55% w/w inert ingredients. When mixed with water to form a dilute pesticide nano-emulsion and applied directly to plants, including leaves stems, flowers and roots at the specified rates, tests showed that economic control of vineyard pests was achieved, particularly for fungal pests such as Botrytis and/or powdery mildew, and insect pests such as aphids, whiteflies, leafhoppers, and/or mites (e.g. spider mites).

Characteristics of Pesticide 1 are as follows:
Highly concentrated formulation—approximately 1.50 litres of Pesticide 1 per hectare
Readily miscible in water
May be tank mixed with most crop protection products and nutrients. Used under warm or cool growing conditions
Vine-safe for all varietals of wine grapes
Compatible with Integrated Pest Management (IPM) Organic and Sustainable Production Practices
Can be used as a Biological Control Alternative (BCA) product
Minimal personal equipment required because of no or negligible toxicity to humans

Zero-day Post Harvest Interval (PHI)
4-hour re-entry period
Enhances the performance against pests while minimizing the risks associated with conventional horticultural oils
Does not affect vine respiration or veraison (i.e. onset of ripening)
Odor-free, no detectable residue
Extremely low risk of pest resistance
Low volatile organic compounds (VOC)

### Example 2

The efficacy of Pesticide 1 was compared with a mixture of pesticides comprising a commercially available emulsifiable suspension mycoinsecticide (Pesticide C1) and a commercially available microbial insecticide (Pesticide C2). Pesticide C1 comprises 11.3% active ingredient (Beauveria bassiana Strain GHA) and 88.7% inert ingredients and Pesticide C2 comprises a naturally occurring fungus (Paecilomyces fumosoroseus).

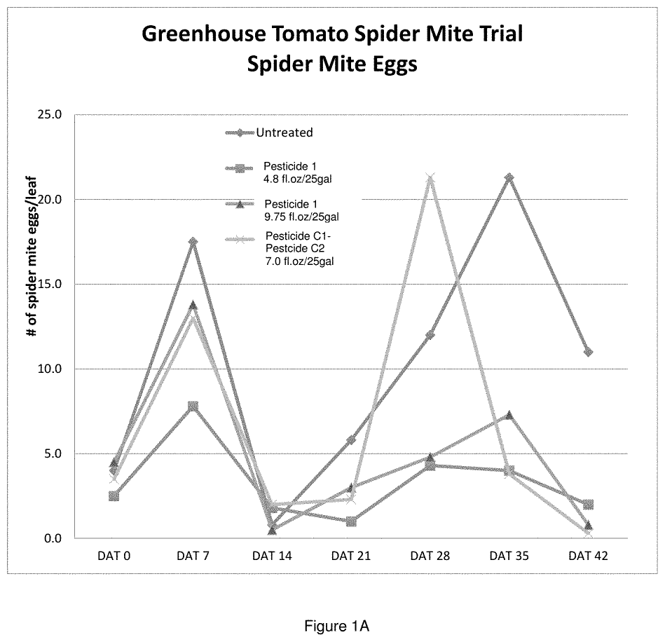

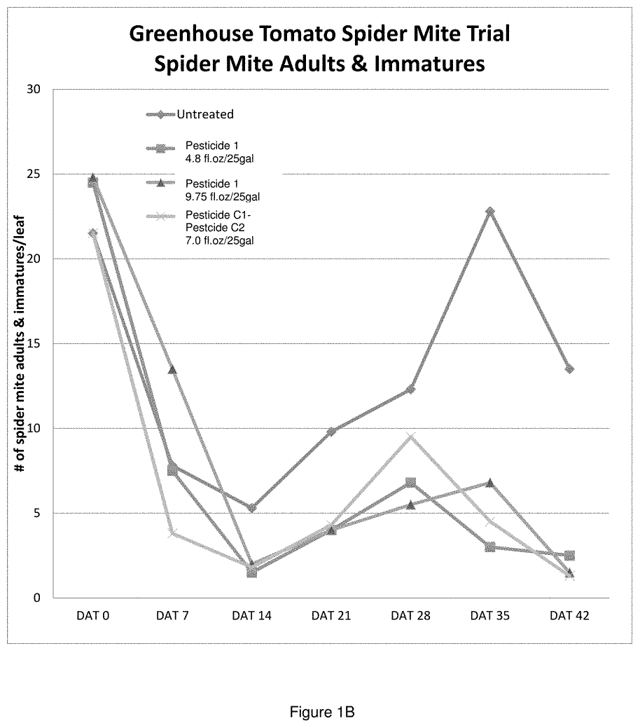

A formulation comprising Pesticide 1 in an amount of 4.8 fluid ounce (fl.oz)/25 gallon (gal) and another formulation comprising Pesticide 1 in an amount of 9.75 fl.oz/25 gal were prepared and compared to a formulation comprising Pesticide C1- Pesticide C2 in an amount of 7.0 fl.oz/25 gal. The efficacy results against spider mite eggs is shown in FIG. 1A and the efficacy results against spider mite adults and immatures are shown in FIG. 1B.

With regards to FIG. 1A and 1B, it was shown that the formulation comprising Pesticide 1 in an amount of 4.8 fl.oz/25 gal (0.15% v/v) showed superior results most of the time, even after prolonged periods of time, compared to the formulation comprising Pesticide 1 in an amount of 9.75 fl.oz/25 gal (0.30% v/v). Advantageously, both formulations comprising Pesticide 1 were able to reduce the number of spider mite eggs, spider mite adults and immatures, as evidenced by the drastic decrease in the number of spider mite eggs, spider mite adults and immatures relative to the untreated controls. Surprisingly, both formulations comprising Pesticide 1 also showed superior results as compared to the formulation comprising Pesticide C1- Pesticide C2 at day 28 demonstrating Pesticide 1 had greater reliability for controlling pests than the industry standard. As such, it also demonstrates that a relatively small amount of Pesticide 1 (0.15% v/v) is sufficient in reducing the number of spider mite eggs, spider mite adults and immatures.

Comparatively, Pesticide 1 performed similarly as conventional horticultural pesticides known in the art that are applied between 1.0% and 2.0% v/v formulation or 0.90 to 0.98% w/w horticultural oil. However, in the present invention this level of pest control was achieved at levels as low as 0.15% v/v of the formulation or a horticultural oil concentration of 0.068% v/v.

### Example 3

Another pesticide nano-emulsion (Pesticide 2) in accordance with embodiments of the present invention was developed. Pesticide 2 is a non-volatile vegetable oil-based pesticide comprising 34% w/w palm oil as an active ingredient and 66% w/w inert ingredients.

Similar to Pesticide 1, Pesticide 2 also contain soybean as an active ingredient and based on Table 1, it is shown to perform well at a dilution rate of 9.75 fl.oz/25 gal (0.3% v/v or 3.0ml/L). In particular, Pesticide 2 was found to effectively minimize mites on strawberries and mini-roses, successfully reduce the incidence of botrytis on strawberry fruits, reduce the incidence of white rust on chrysanthemums and effectively curb/minimize the population of whiteflies on tomatoes. The afore-mentioned performance data showed consistency at a lower horticultural oil concentration (45% w/w in Pesticide 1 versus 34% w/w in Pesticide 2).

TABLE 1

| Test | Treatment Efficacy (%) |
|---|---|
| Treatment efficacy on mites on | 73.1 |
| strawberries | |
| Treatment efficacy on botrytis on | 70.2 |
| strawberries | |
| Treatment efficacy on mites on roses | 85.4 |
| Treatment efficacy on white rust on | 93.3 |
| chrysanthemum | |
| Treatment efficacy on white flies on | 76.0 |
| tomatoes | |
| Treatment efficacy on powdery mildew | 97.1 |
| on tomatoes | |

It should be further appreciated by the person skilled in the art that variations and combinations of features described above, not being alternatives or substitutes, may be combined to form yet further embodiments falling within the intended scope of the invention.

Furthermore, although individual embodiments have been discussed it is to be understood that the invention covers combinations of the embodiments that have been discussed as well.

1. A pesticide nano-emulsion comprising:
(a) a horticultural oil as an active ingredient;
(b) a mixture of inert ingredients comprising:
(i) an emulsifier;
(ii) a stabilizer; and
(iii) a surfactant; and
(c) a solvent;
wherein the horticultural oil is dispersed as droplets in the solvent to form the nano-emulsion.

2. The pesticide nano-emulsion according to claim 1, wherein the droplets comprise an average size in the range of 50 nm to 350 nm.

3. The pesticide nano-emulsion according to claim 2, wherein the droplets comprise an average size in the range of 100 nm to 250 nm.

4. The pesticide nano-emulsion according to claim 1, wherein the stabilizer is in a concentration range of 0.5% to 5.0% w/w of the pesticide nano-emulsion.

5. The pesticide nano-emulsion according to claim 1, wherein the mixture of inert ingredients further comprises a sticking agent in a concentration range of 0.25% to 3.00% w/w of the pesticide nano-emulsion.

6. The pesticide nano-emulsion according to claim 1, wherein the horticultural oil is in a concentration range of less than 90% w/w of the pesticide nano-emulsion.

7. The pesticide nano-emulsion according to claim 6, wherein the horticultural oil is in a concentration range of 20.0% to 70.0% w/w of the pesticide nano-emulsion and the mixture of inert ingredients is in a concentration of 30.0% to 80.0% w/w of the pesticide nano-emulsion.

8. The pesticide nano-emulsion of claim 7, wherein the horticultural oil is in an amount of 45.0% w/w of the pesticide nano-emulsion and the mixture of inert ingredients is in a concentration of 55.0% w/w of the pesticide nano-emulsion.

9. The pesticide nano-emulsion according to claim 1, wherein the emulsifier is in a concentration range of 0.1% to 10.0% w/w of the pesticide nano-emulsion.

10. The pesticide nano-emulsion according to claim 1, wherein the surfactant is in a concentration range of 0.5% to 30.0% w/w of the pesticide nano-emulsion.

11. The pesticide nano-emulsion according to claim 1, wherein the solvent is at least 0.25% w/w of the pesticide nano-emulsion.

12. The pesticide nano-emulsion according to claim 11, wherein the solvent comprises a first solvent and a second solvent, wherein the first solvent is water and the second solvent is at least 0.25% w/w of the pesticide nano-emulsion.

13. The pesticide nano-emulsion according to claim 1, wherein the pesticide nano-emulsion is adapted to be diluted about 100 times to 800 times to form a dilute pesticide nano-emulsion.

14. The pesticide nano-emulsion according to claim 13, wherein the horticultural oil is in a concentration range of 0.056% to 0.45% v/v of the dilute pesticide nano-emulsion.

15. The pesticide nano-emulsion according to claim 13, wherein the stabilizer is in a concentration range of 0.001% to 0.017% v/v of the dilute pesticide nano-emulsion.

16. A pesticide formulation comprising an effective amount of at least one pesticide and an adjuvant nano-emulsion comprising:
(a) a horticultural oil as an active ingredient;
(b) a mixture of inert ingredients comprising:
(i) an emulsifier;
(ii) a stabilizer; and
(iii) a surfactant; and
(c) a solvent,
wherein the horticultural oil is dispersed as droplets in the solvent to form the adjuvant nano-emulsion.

17. The pesticide nano-emulsion according to claim 14, wherein the stabilizer is in a concentration range of 0.001% to 0.017% v/v of the dilute pesticide nano-emulsion.
